(19) United States
(12) Patent Application Publication
(10) Pub. No.: US 2017/0153516 A1
(43) Pub. Date: Jun. 1, 2017

(54) PIXEL STRUCTURE AND LIQUID CRYSTAL DISPLAY PANEL

(71) Applicant: Shenzhen China Star Optoelectronics Technology Co. Ltd., Shenzhen, Guangdong (CN)

(72) Inventors: Chengzhong Yu, Shenzhen City (CN); Min Tang, Shenzhen City (CN); Yungjui Lee, Shenzhen City (CN)

(21) Appl. No.: 14/786,169

(22) PCT Filed: Oct. 12, 2015
(86) PCT No.: PCT/CN2015/091716

§ 371 Date: Oct. 22, 2015

(30) Foreign Application Priority Data
Aug. 27, 2015 (CN) 201510535070.1

(51) Int. Cl. G02F 1/1343; G09G 3/20; G09G 3/36

(52) U.S. Cl. CPC G02F 1/134336; G09G 3/3607; G09G 3/2003; G09G 2300/0443; G09G 2300/0452; G02F 2201/52; G02F 2001/134345

(57) ABSTRACT

The present invention provides a pixel structure and a liquid crystal display panel. Areas of the red sub pixel (R) and the green sub pixel (G) are set to be equal, and an area of the blue sub pixel (B) is smaller than the area of the red sub pixel (R) or the green sub pixel (G), and an area of the white sub pixel (W) is not less than the area of the red sub pixel (R) or the green sub pixel (G). By adjusting the area ratio of the red sub pixel (R), the green sub pixel (G), the blue sub pixel (B) and the white sub pixel (W) to reduce the area of the blue sub pixel (B) and relatively enlarge the area of the white sub pixel (W), the white dot coordinate in the RGBW liquid crystal display panel can be adjusted.

### FIELD OF THE INVENTION

The present invention relates to a display technology field, and more particularly to a pixel structure and a liquid crystal display panel.

### BACKGROUND OF THE INVENTION

The LCD (Liquid Crystal Display) possesses many advantages of being ultra thin, power saved and radiation free. It has been widely utilized in, such as LCD TVs, mobile phones, Personal Digital Assistant (PDA), digital cameras, laptop screens or notebook screens, and dominates the flat panel display field.

The display panel is an important component of the LCD devices. For the LCD, the structure of the liquid crystal display panel generally comprises a Color Filter (CF), a Thin Film Transistor Array Substrate (TFT Array Substrate), and a Liquid Crystal Layer arranged between the two substrates. The working principle is that the light of backlight module is reflected to generate images by applying driving voltages to the two glass substrate for controlling the rotations of the liquid crystal molecules.

The traditional liquid crystal display panel comprises a plurality of pixels alignment in array, and each pixel comprises a red (R), a green (G), a blue (B), three sub pixels. The R, G, B color filters utilized in prior art are all absorption type color resists. When the light is incoming, only the light of corresponding color can permeate, the lights of other two colors are both absorbed, which make the transmission of the display panel is lower, and the brightness is insufficient, and the mixture efficiency of the RGB three primary colors is lower. It results in the large power consumption of the display panel and restricts the optimization of the display panel. Therefore, the display technology of forming red, green, blue, white, four sub pixels in one pixel appears.

FIG. 1 shows a pixel structure of a RGBW liquid crystal display panel according to prior art, comprising a plurality of pixel units arranged in array, and each pixel unit comprises a red sub pixel R, a green sub pixel G, a blue sub pixel B and a white sub pixel W. The red sub pixel R, the green sub pixel G, the blue sub pixel B and the white sub pixel W are sequentially aligned from left to right along the horizontal direction in one pixel unit. The areas of the red sub pixel R, the green sub pixel G, the blue sub pixel B and the white sub pixel W are the same. The white sub pixel W is a transparent color resist, and the transmittance can reach above 99%. With the addition of the white sub pixel W, the transmittance of the liquid crystal display panel has got the terrific promotion to reduce the power consumption of the backlight.

However, in the liquid crystal display panel utilizing the RGBW technology according to prior art, with the added white sub pixel W, all the output values of the red sub pixel R, the green sub pixel G and the blue sub pixel B are decreased. Therefore, as the entire brightness of the image maintains to be the same, the color saturation descends. Besides, the white purity mixed with R, G, B three primary colors according to the present RGBW technology is different from the white purity of the white sub pixel W. Consequently, the white color according to the present RGBW technology has shift in comparison with the white color of the display panel only possessing RGB three primary colors and results in the bias blue in the display result.

The white color of the present RGBW display panel is mixed with the white color mixed by the RGB three primary colors sub pixels and the white color sub pixel W. When the backlight frequency spectrums, the polarizers, the liquid crystals, and the color filters of the present RGBW display panel and the traditional RGB display panel are the same but only the pixel structures are different. The respective white dot coordinates are shown in FIG. 2. The s represents the white dot coordinate of the present RGBW display panel. The s1 represents the white dot coordinate mixed with R, G, B three primary colors sub pixels in the present RGBW display panel. The s2 represents the white dot coordinate of the white sub pixel W in the present RGBW display panel. The s′ represents the white dot coordinate of the traditional RGB display panel. The std represents the expected white dot coordinate. The allowable coordinate deviation range of std is (0.280±0.01, 0.290±0.01). According to the measurement result, the transmittance of the present RGBW display panel is 7.95%. The coordinate positions of the respective white dot coordinates in the CIE1931 color coordinate system is shown in FIG. 3 and FIG. 4. The white dot coordinate s of the present RGBW display panel slants small in comparison with x-coordinate value and y-coordinate value of the expected white dot coordinate std, and biases to blue, which in the bias blue in the display result.

### SUMMARY OF THE INVENTION

An objective of the present invention is to provide a pixel structure capable of adjusting the white dot coordinate in the RGBW liquid crystal display panel to solve the bias blue issue of the display image for raising the transmittance of the liquid crystal display panel in advance.

Another objective of the present invention is to provide a liquid crystal display panel capable of adjusting the white dot coordinate in the panel to solve the bias blue issue of the display image for raising the transmittance of the liquid crystal display panel in advance.

For realizing the aforesaid objectives, the present invention provides a pixel structure, comprising a plurality of pixel units arranged in array, and each pixel unit comprises a red sub pixel, a green sub pixel, a blue sub pixel and a white sub pixel; in respective pixel units, the red sub pixel, the green sub pixel, the blue sub pixel and the white sub pixel are aligned with the same order along a horizontal direction;

areas of the red sub pixel and the green sub pixel are equal, and an area of the blue sub pixel is smaller than the area of the red sub pixel or the green sub pixel, and an area of the white sub pixel is not less than the area of the red sub pixel or the green sub pixel.

Selectably, the area of the white sub pixel is equal to the area of the red sub pixel or the green sub pixel, and an area ratio of the red sub pixel, the green sub pixel, the blue sub pixel and the white sub pixel is 1.14:1.14:0.58:1.14.

Selectably, the area of the white sub pixel is larger than the area of the red sub pixel or the green sub pixel, and an area ratio of the red sub pixel, the green sub pixel, the blue sub pixel and the white sub pixel is 1:1:0.4-0.5:1.5-1.6.

In respective pixel units, the red sub pixel, the green sub pixel, the blue sub pixel and the white sub pixel are sequentially aligned from left to right along the horizontal direction.

The present invention further provides a liquid crystal display, comprising a plurality of pixel units arranged in array, and each pixel unit comprises a red sub pixel, a green sub pixel, a blue sub pixel and a white sub pixel; in respective pixel units, the red sub pixel, the green sub pixel, the blue sub pixel and the white sub pixel are aligned with the same order along a horizontal direction;

areas of the red sub pixel and the green sub pixel are equal, and an area of the blue sub pixel is smaller than the area of the red sub pixel or the green sub pixel, and an area of the white sub pixel is not less than the area of the red sub pixel or the green sub pixel.

Selectably, the area of the white sub pixel is equal to the area of the red sub pixel or the green sub pixel, and an area ratio of the red sub pixel, the green sub pixel, the blue sub pixel and the white sub pixel is 1.14:1.14:0.58:1.14.

Selectably, the area of the white sub pixel is larger than the area of the red sub pixel or the green sub pixel, and an area ratio of the red sub pixel, the green sub pixel, the blue sub pixel and the white sub pixel is 1:1:0.4-0.5:1.5-1.6.

In respective pixel units, the red sub pixel, the green sub pixel, the blue sub pixel and the white sub pixel are sequentially aligned from left to right along the horizontal direction.

The present invention further provides a liquid crystal display, comprising a plurality of pixel units arranged in array, and each pixel unit comprises a red sub pixel, a green sub pixel, a blue sub pixel and a white sub pixel; in respective pixel units, the red sub pixel, the green sub pixel, the blue sub pixel and the white sub pixel are aligned with the same order along a horizontal direction;

areas of the red sub pixel and the green sub pixel are equal, and an area of the blue sub pixel is smaller than the area of the red sub pixel or the green sub pixel, and an area of the white sub pixel is not less than the area of the red sub pixel or the green sub pixel;

wherein the area of the white sub pixel is equal to the area of the red sub pixel or the green sub pixel, and an area ratio of the red sub pixel, the green sub pixel, the blue sub pixel and the white sub pixel is 1.14:1.14:0.58:1.14;

wherein in respective pixel units, the red sub pixel, the green sub pixel, the blue sub pixel and the white sub pixel are sequentially aligned from left to right along the horizontal direction.

The benefits of the present invention are: in the pixel structure and the liquid crystal display panel provided by the present invention, by adjusting the area ratio of the red sub pixel, the green sub pixel, the blue sub pixel and the white sub pixel to reduce the area of the blue sub pixel and relatively enlarge the area of the white sub pixel, the white dot coordinate in the RGBW liquid crystal display panel can be adjusted to make the white dot coordinate closer to an expectation value to solve the bias blue issue of the display image for improving the image display quality and raising the transmittance of the liquid crystal display panel in advance.

In order to better understand the characteristics and technical aspect of the invention, please refer to the following detailed description of the present invention is concerned with the diagrams, however, provide reference to the accompanying drawings and description only and is not intended to be limiting of the invention.

### BRIEF DESCRIPTION OF THE DRAWINGS

The technical solution and the beneficial effects of the present invention are best understood from the following detailed description with reference to the accompanying figures and embodiments.

In drawings,

FIG. 1 is a pixel structure diagram of a RGBW liquid crystal display panel according to prior art;

FIG. 2 is a white dot coordinate table of a RGBW liquid crystal display panel according to prior art;

FIG. 3 is a coordinate position diagram corresponded with respective white dots in the CIE1931 color coordinate system in a RGBW liquid crystal display panel according to prior art;

FIG. 4 is an enlarged diagram of the coordinate positions of the respective white dots shown in FIG. 3;

FIG. 5 is a diagram of the first embodiment according to a pixel structure of the present invention;

FIG. 6 is a diagram of the second embodiment according to a pixel structure of the present invention.

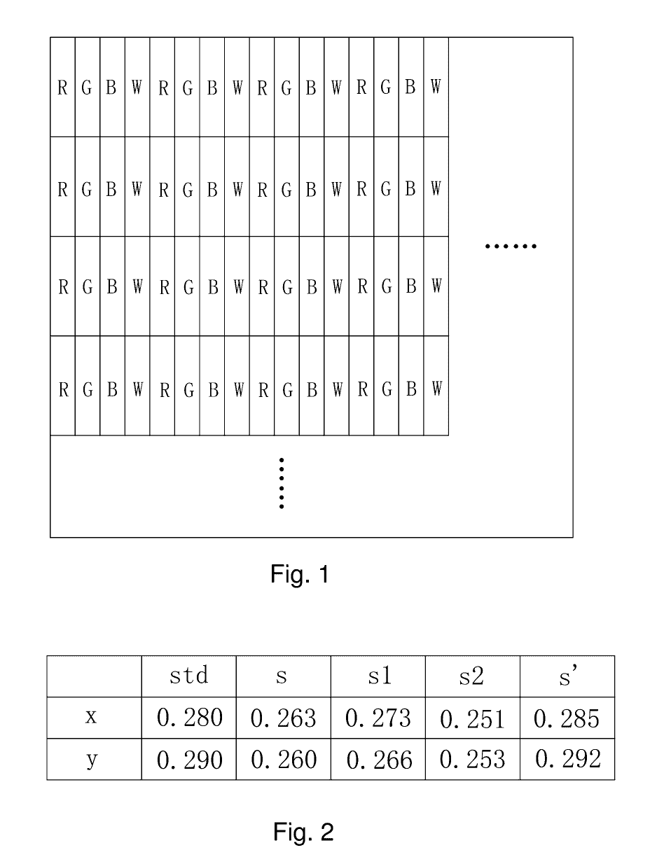

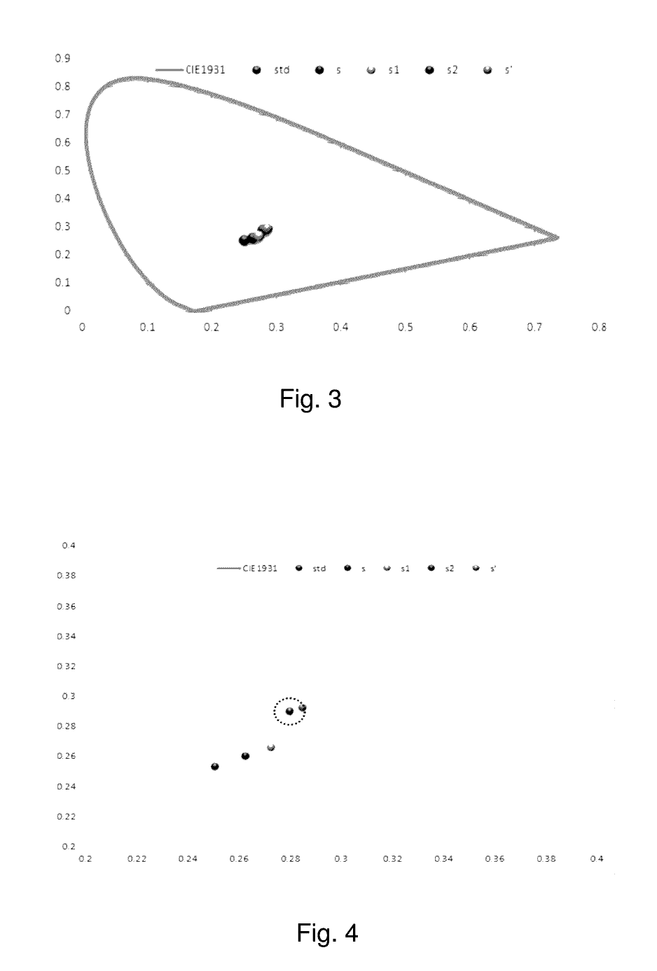

### DETAILED DESCRIPTION OF PREFERRED EMBODIMENTS

For better explaining the technical solution and the effect of the present invention, the present invention will be further described in detail with the accompanying drawings and the specific embodiments.

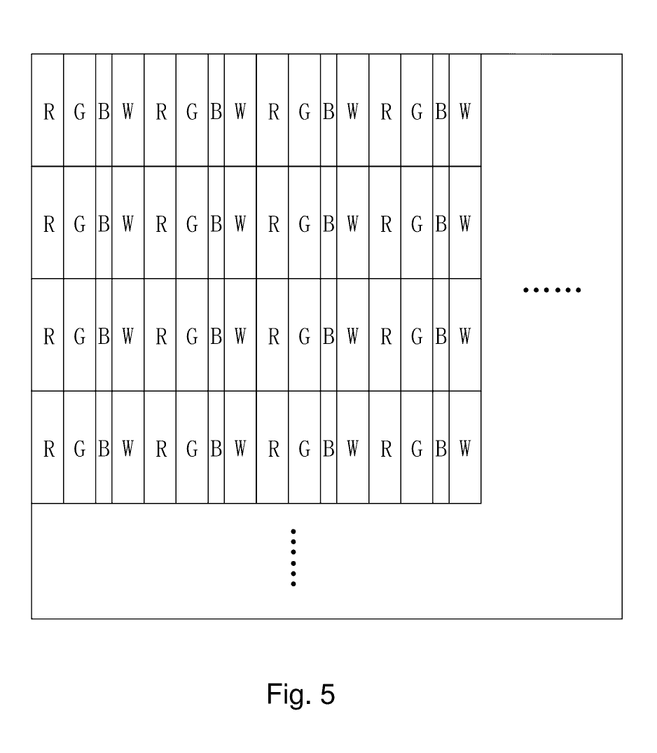

The present invention provides a pixel structure. FIG. 5 shows the first embodiment according to a pixel structure of the present invention, comprising a plurality of pixel units arranged in array, and each pixel unit comprises a red sub pixel R, a green sub pixel G, a blue sub pixel B and a white sub pixel W. In respective pixel units, the red sub pixel R, the green sub pixel G, the blue sub pixel B and the white sub pixel W are aligned with the same order along a horizontal direction.

Areas of the red sub pixel R and the green sub pixel G are equal, and an area of the blue sub pixel B is smaller than the area of the red sub pixel R or the green sub pixel G, and an area of the white sub pixel W is not less than the area of the red sub pixel R or the green sub pixel G. In the first embodiment, the area of the white sub pixel W is equal to the area of the red sub pixel R or the green sub pixel G, and preferably, an area ratio of the red sub pixel R, the green sub pixel G, the blue sub pixel B and the white sub pixel W is 1.14:1.14:0.58:1.14.

Significantly, as long as the alignment sequence of the red sub pixel R, the green sub pixel G, the blue sub pixel B and the white sub pixel W are the same in the respective pixel units, the present invention does not restrict the specific alignment sequence of the red sub pixel R, the green sub pixel G, the blue sub pixel B and the white sub pixel W in one pixel unit. In other words, according to the calculation formula of the alignment combinations, the alignment sequence of the sub pixels of four colors, the red sub pixel R, the green sub pixel G, the blue sub pixel B and the white sub pixel W can be determined according to any one of 24 alignment ways. Preferably, as shown in FIG. 5, in respective pixel units, the red sub pixel R, the green sub pixel G, the blue sub pixel B and the white sub pixel W are sequentially aligned from left to right along the horizontal direction.

Based on the aforesaid pixel structure, the present invention further provides a liquid crystal display panel. The liquid crystal display panel comprises the pixel structure as shown in FIG. 5. The description of the pixel structure shown in FIG. 5 is not repeated here.

In the liquid crystal display panel, the area ratio of the red sub pixel R, the green sub pixel G, the blue sub pixel B and the white sub pixel W is set to be 1.14:1.14:0.58:1.14. With the chroma simulation, the white dot coordinate of the liquid crystal display panel is adjusted to be (0.282, 0.292), which is closer to the expected white dot coordinate std (0.280, 0.290) than the white dot coordinate s (0.263, 0.260) of the RGBW liquid crystal display panel according to prior art, and the deviation with the expected white dot coordinate std is very small. The bias blue issue of the display image can be solved to improve the image display quality. Besides, the transmittance of the blue sub pixel B is the lowest, then the area ratio of the red sub pixel R, the green sub pixel G, the blue sub pixel B and the white sub pixel W is set to be 1.14:1.14:0.58:1.14 to reduce the area of the blue sub pixel B and relatively enlarge the area of the white sub pixel W. Overall, the transmittance of the panel is raised. The transmittance can be raised from the existing 7.95% up to 8.83%.

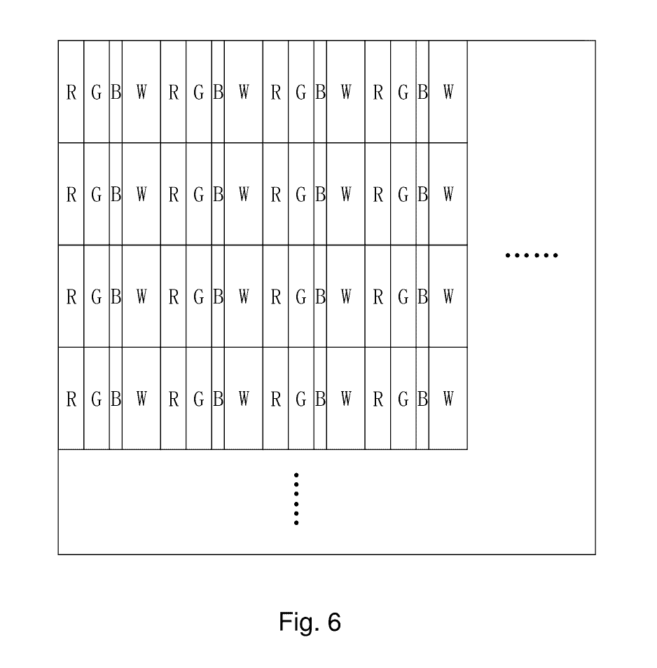

FIG. 6 shows the second embodiment according to a pixel structure of the present invention, comprising a plurality of pixel units arranged in array, and each pixel unit comprises a red sub pixel R, a green sub pixel G, a blue sub pixel B and a white sub pixel W. In respective pixel units, the red sub pixel R, the green sub pixel G, the blue sub pixel B and the white sub pixel W are aligned with the same order along a horizontal direction.

Areas of the red sub pixel R and the green sub pixel G are equal, and an area of the blue sub pixel B is smaller than the area of the red sub pixel R or the green sub pixel G, and an area of the white sub pixel W is not less than the area of the red sub pixel R or the green sub pixel G. In the second embodiment, the area of the white sub pixel W is equal to the area of the red sub pixel R or the green sub pixel G, and preferably, an area ratio of the red sub pixel R, the green sub pixel G, the blue sub pixel B and the white sub pixel W is 1:1:0.4-0.5:1.5-1.6.

Preferably, in respective pixel units, the red sub pixel R, the green sub pixel G, the blue sub pixel B and the white sub pixel W are sequentially aligned from left to right along the horizontal direction.

Based on the aforesaid pixel structure, the present invention further provides a liquid crystal display panel. The liquid crystal display panel comprises the pixel structure as shown in FIG. 6. The description of the pixel structure shown in FIG. 6 is not repeated here.

In the liquid crystal display panel, the area ratio of the red sub pixel R, the green sub pixel G, the blue sub pixel B and the white sub pixel W is set to be 1:1:0.4-0.5:1.5-1.6. With the chroma simulation, the white dot coordinate of the liquid crystal display panel is adjusted to be (0.281, 0.291), and the deviation with the expected white dot coordinate std (0.280, 0.290) is diminished in advance. The bias blue issue of the display image can be solved in a better way to improve the image display quality. Besides, the transmittance of the blue sub pixel B is the lowest, then the area ratio of the red sub pixel R, the green sub pixel G, the blue sub pixel B and the white sub pixel W is set to be 1:1:0.4-0.5:1.5-1.6 to reduce the area of the blue sub pixel B and relatively enlarge the area of the white sub pixel W. The transmittance of the panel is raised. The transmittance can be raised from the existing 7.95% up to 9.9%-10.3%.

In conclusion, in the pixel structure and the liquid crystal display panel of the present invention, by adjusting the area ratio of the red sub pixel, the green sub pixel, the blue sub pixel and the white sub pixel to reduce the area of the blue sub pixel and relatively enlarge the area of the white sub pixel, the white dot coordinate in the RGBW liquid crystal display panel can be adjusted to make the white dot coordinate closer to an expectation value to solve the bias blue issue of the display image for improving the image display quality and raising the transmittance of the liquid crystal display panel in advance.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A pixel structure, comprising a plurality of pixel units arranged in array, and each pixel unit comprises a red sub pixel, a green sub pixel, a blue sub pixel and a white sub pixel; in respective pixel units, the red sub pixel, the green sub pixel, the blue sub pixel and the white sub pixel are aligned with the same order along a horizontal direction;
areas of the red sub pixel and the green sub pixel are equal, and an area of the blue sub pixel is smaller than the area of the red sub pixel or the green sub pixel, and an area of the white sub pixel is not less than the area of the red sub pixel or the green sub pixel.

2. The pixel structure according to claim 1, wherein the area of the white sub pixel is equal to the area of the red sub pixel or the green sub pixel, and an area ratio of the red sub pixel, the green sub pixel, the blue sub pixel and the white sub pixel is 1.14:1.14:0.58:1.14.

3. The pixel structure according to claim 1, wherein the area of the white sub pixel is larger than the area of the red sub pixel or the green sub pixel, and an area ratio of the red sub pixel, the green sub pixel, the blue sub pixel and the white sub pixel is 1:1:0.4-0.5:1.5-1.6.

4. The pixel structure according to claim 1, wherein in respective pixel units, the red sub pixel, the green sub pixel, the blue sub pixel and the white sub pixel are sequentially aligned from left to right along the horizontal direction.

5. A liquid crystal display, comprising a plurality of pixel units arranged in array, and each pixel unit comprises a red sub pixel, a green sub pixel, a blue sub pixel and a white sub pixel; in respective pixel units, the red sub pixel, the green sub pixel, the blue sub pixel and the white sub pixel are aligned with the same order along a horizontal direction;
areas of the red sub pixel and the green sub pixel are equal, and an area of the blue sub pixel is smaller than the area of the red sub pixel or the green sub pixel, and an area of the white sub pixel is not less than the area of the red sub pixel or the green sub pixel.

6. The liquid crystal display panel according to claim 5, wherein the area of the white sub pixel is equal to the area of the red sub pixel or the green sub pixel, and an area ratio of the red sub pixel, the green sub pixel, the blue sub pixel and the white sub pixel is 1.14:1.14:0.58:1.14.

7. The liquid crystal display panel according to claim 5, wherein the area of the white sub pixel is larger than the area of the red sub pixel or the green sub pixel, and an area ratio of the red sub pixel, the green sub pixel, the blue sub pixel and the white sub pixel is 1:1:0.4-0.5:1.5-1.6.

8. The liquid crystal display according to claim 5, wherein in respective pixel units, the red sub pixel, the green sub pixel, the blue sub pixel and the white sub pixel are sequentially aligned from left to right along the horizontal direction.

9. A liquid crystal display, comprising a plurality of pixel units arranged in array, and each pixel unit comprises a red sub pixel, a green sub pixel, a blue sub pixel and a white sub pixel; in respective pixel units, the red sub pixel, the green sub pixel, the blue sub pixel and the white sub pixel are aligned with the same order along a horizontal direction;
areas of the red sub pixel and the green sub pixel are equal, and an area of the blue sub pixel is smaller than the area of the red sub pixel or the green sub pixel, and an area of the white sub pixel is not less than the area of the red sub pixel or the green sub pixel;
wherein the area of the white sub pixel is equal to the area of the red sub pixel or the green sub pixel, and an area ratio of the red sub pixel, the green sub pixel, the blue sub pixel and the white sub pixel is 1.14:1.14:0.58:1.14;
wherein in respective pixel units, the red sub pixel, the green sub pixel, the blue sub pixel and the white sub pixel are sequentially aligned from left to right along the horizontal direction.
